(19) United States
(12) Patent Application Publication
(10) Pub. No.: US 2004/0057455 A1
(43) Pub. Date: Mar. 25, 2004

(54) Wireless LAN card and method of controlling the same

(75) Inventor: Yoon-Man Choi, Seoul City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/412,241

(22) Filed: Apr. 14, 2003

(30) Foreign Application Priority Data
Sep. 19, 2002 (KR) 2002-57235

(51) Int. Cl. H04L 12/66

(52) U.S. Cl. 370/463; 370/338; 370/328

(57) ABSTRACT

A wireless LAN card to be connected to a portable computer having a main body with a PCMCIA socket, includes a wireless transmission board including a wireless sending/receiving part to modulate and demodulate packet of a specific frequency modulation range and to wirelessly send and receive data; and a wireless LAN board including a controller to sense whether or not the wireless transmission board is connected to the wireless LAN board, to convert the data received through the PCMCIA socket into the packet data, and to transmit the packet data to the wireless transmission board. With this configuration, a wireless LAN card and a operation of controlling the same is provided, in which the wireless LAN card is usable as a memory card and a wireless sending/receiving part thereof is easily replaceable for one of a desired specification.

### CROSS-REFERENCE TO RELATED APPLICATION

This application claims the benefit of Korean Application No. 2002-57235, filed Sep. 19, 2002, in the Korean Intellectual Property Office, the disclosure of which is incorporated herein by reference.

### BACKGROUND OF THE INVENTION

1. Field of the Invention

The present invention relates to a wireless LAN card and a method of controlling the same, and more particularly, to a wireless LAN card and a method of controlling the same, in which an RF (radio frequency) part is detachably connected.

2. Description of the Related Art

An OSI (open system interconnection) protocol layer standardized by an OSI reference model defines a hierarchy of seven layers. The lowermost layer of the OSI model is a physical layer. A data-link layer containing a MAC (media access control) sublayer and a LLC (logical link control) sublayer is directly above the physical layer. Further, a network layer to set up an Internet protocol is above the data-link layer, and a transport layer to set up a TCP (transmission control protocol) is above the network layer. A session layer, a presentation layer, and an application layer being uppermost layers are in sequence above the transport layer.

Further, a LAN (local area network) card is employed as an interface to send and receive data between any two computers in a network, and furnishes the physical layer operation in the OSI protocol layers.

Further, a PCMCIA (personal computer memory card international association) type card is suitable to provide extended capability to a portable computer, and is connected to the portable computer through a PCMCIA bus adapter communicating with a standard bus such as, for example, an ISA (industry standard architecture) bus, an EISA (extended industry standard architecture) bus, a PCI (peripheral component interconnect) bus.

Further, a wireless LAN card of the PCMCIA type card furnishes both the physical layer operation and the MAC layer operation, and communicates with the portable computer by control of the PCMCIA controller.

The wireless LAN card sends and receives data through airwaves, so that the physical layer is needed which can convert a baseband signal into an airwave band of the wireless connection. Hence, the physical layer includes an A/D (analog/digital) converter, a D/A converter, a modulator, a demodulator, and an antenna.

A family of specifications for wireless LANs developed by a working group of IEEE (institute of electrical and electronics engineers) is 802.11, and is currently part of a series of wireless specifications together with 802.11a, 802.11b, and 802.11g. All four specifications use Ethernet protocol and CSMA/CA (carrier sense multiple access with collision avoidance) to path share.

A modulation operation used in 802.11 is PSK (phase-shift keying), and a modulation operation selected for 802.11b (often called Wi-Fi) upgraded from the 802.11 specification is known as CCK (complementary code keying), which allows higher data speeds and is less susceptible to a multipath-propagation interface. The 802.11b (Wi-Fi) specification operates in a 2.4 GHz range, offering data speeds up to 11 Mbps (megabits per second). Further, the 802.11a specification upgraded from the 802.11b specification applies to wireless ATM (asynchronous transfer mode) systems, operates at radio frequencies (RF) band between 5 GHz and 6 GHz, and uses a modulation operation known as OFDM (orthogonal frequency-division multiplexing) which makes possible data speeds as high as 54 Mbps.

Thus, the PCMCIA wireless LAN card for the 802.11b specification should have a CCK demodulator and a 2.4 GHz RF processing part. The PCMCIA wireless LAN card for the 802.11a specification should have an OFDM demodulator and a 5 GHz RF processing part. The PCMCIA wireless LAN card for both the 802.11a and 802.11b specifications should have the CCK and OFDM demodulators and the 2.4 GHz and 5 GHz RF processing parts.

However, because a regulation of a 5 GHz band for the 802.11a specification varies according to regulations of each nation, the PCMCIA wireless LAN card for the 802.1a specification should be individually manufactured with a radio frequency of the PCMCIA wireless LAN card being tuned according to a selected nation, thereby decreasing productive efficiency of the PCMCIA wireless LAN card. Further, the PCMCIA wireless LAN card for both the 802.11a and 802.11b specifications includes two demodulators and two RF processing parts all together, so that costs of the PCMCIA wireless LAN card are relatively expensive. Also, the 802.11a and 802.11b specifications are compatible with each other in the MAC layers, so that if a user replaces the PCMCIA wireless LAN card of the 802.11a specification or 802.11b specification with another specification, components for one MAC layer are wasted.

Therefore, if the physical layer is detachably provided in the PCMCIA wireless LAN card, the PCMCIA wireless LAN card is easily changeable for another specification by changing only the physical layer. Further, a PCMCIA memory card is identical with the PCMCIA wireless LAN card in the specification except for the physical layer, so that if the PCMCIA memory card is combined with the PCMCIA wireless LAN card, the PCMCIA wireless LAN card is variously utilizable.

### SUMMARY OF THE INVENTION

Accordingly, it is an aspect of the present invention to provide a wireless LAN card and a method of controlling the same, in which the wireless LAN card is usable as a memory card and a wireless sending/receiving part thereof is easily replaceable for one of a desired specification.

Additional aspects and/or advantages of the invention will be set forth in part in the description which follows and, in part, will be obvious from the description, or may be learned by practice of the invention.

The above and/or other aspects are achieved by providing a wireless LAN card connectable to a portable computer having a main body with a PCMCIA socket, comprising a wireless transmission board including a wireless sending/receiving part to modulate and demodulate packet data of a specific frequency modulation range and to wirelessly send and receive data; and a wireless LAN board including a controller to sense whether or not the wireless transmission board is connected to the wireless LAN board, to convert data received through the PCMCIA socket into packet data, and to transmit the packet data to the wireless transmission board.

According to an aspect, the wireless LAN board includes a main body connection part connectable to the PCMCIA socket, a connection part to which the wireless transmission board is detachably connected, and a memory part to store the data received through the main body connection part, and the controller operates in a PCMCIA memory card mode when the wireless transmission board is not connected to the wireless LAN board, which stores the data received through the main body connection part in the memory part and reads the data stored in the memory part according to a reading order from the main body so as to transmit the read data to the main body through the PCMCIA socket.

According to a further aspect, the wireless LAN board includes a connection sensing part to sense whether or not the wireless transmission board is connected to the wireless LAN board, and the controller operates in a wireless LAN card mode when the wireless transmission board is connected to the wireless LAN board, the connection sensing part outputting an interrupt signal to the main body and transmits the data from the main body to the wireless transmission board.

According to another aspect, the wireless sending/receiving part includes an antenna; an A/D converter converting an analog signal into a digital signal and/or converting a digital signal into an analog signal; an RF processing part modulating the packet data received from the controller through the A/D converter into a high frequency signal having a specific IF intermediate frequency, and sending a high frequency analog signal through the antenna; and a baseband processing part demodulating a high frequency signal directed by the antenna into a low frequency signal by filtering the IF, and transmits the low frequency signal to the controller through the A/D converter.

According to an aspect, the baseband processing part demodulates the packet data by using one of OFDM and CCK modulation operations.

According to another aspect, the above and/or other aspects may be achieved by providing a method of controlling a wireless LAN card connectable to a portable computer having a main body with a PCMCIA socket, comprising connecting a wireless LAN board to the PCMCIA socket, the wireless LAN board converting data received though the PCMCIA socket into packet data; sensing whether or not a wireless transmission board is connected to the wireless LAN board, the wireless transmission board modulating and demodulating the packet data of a specific frequency modulation range and to wirelessly send and receive data; and sending and receiving the packet data wirelessly via the wireless transmission board when the wireless LAN board and the wireless transmission board are connected.

According to a further aspect, the wireless LAN board includes a memory part to store data received through the PCMCIA socket, and further comprises storing the data in the memory part of the wireless LAN board when the wireless transmission board is not connected to the wireless LAN board; and reading the data stored in the memory part in response to a control of the main body, and transmits the read data to the main body.

According to an aspect, the method further comprises transmitting an interrupt signal to the main body through the PCMCIA socket when the wireless transmission board is connected to the wireless LAN board, so that the wireless LAN card operates in a wireless LAN card mode.

According to another aspect, the wireless transmission board includes an antenna; an RF processing part modulating packet data of a specific frequency modulation range; and a baseband processing part demodulating a high frequency signal directed by the antenna, and further comprises modulating the packet data transmitted from the wireless LAN board into a high frequency signal having a specific IF; and sending and receiving the high frequency signal through the antenna.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a perspective view of a portable computer according to an embodiment of the present invention;

FIG. 2 is a block diagram showing a PCMCIA wireless LAN card of FIG. 1;

FIGS. 3A-3B are block diagrams illustrating a circuit diagram of a second board sensing part of FIG. 2; and

FIG. 4 is a control flowchart of a wireless LAN card according to the present invention.

### DESCRIPTION OF THE PREFERRED EMBODIMENT

Reference will now be made in detail to the embodiment of the present invention, examples of which are illustrated in the accompanying drawings, wherein like reference numerals refer to like elements throughout. The embodiment is described below in order to explain the present invention by referring to the figures.

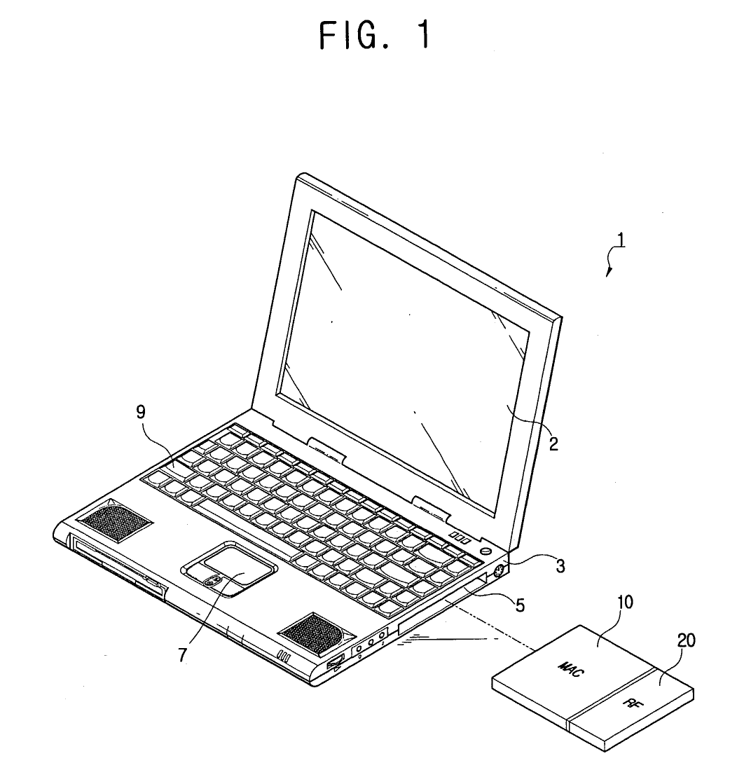

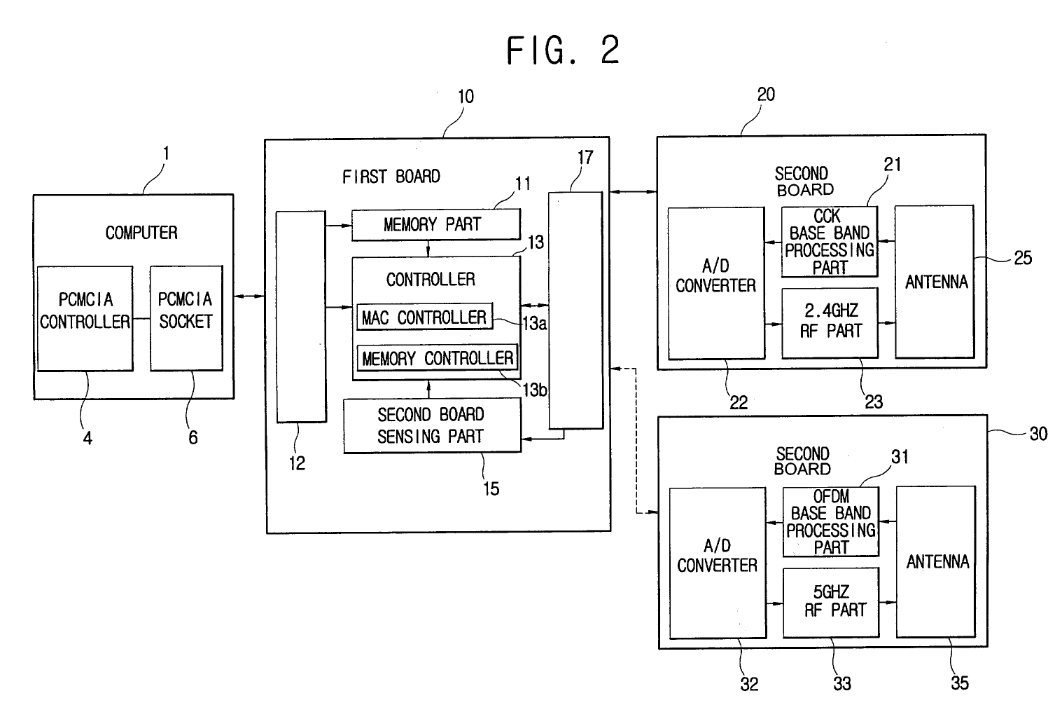

FIG. 1 is a perspective view of a portable computer according to an embodiment of the present invention. As shown therein, a portable computer 1 comprises a main body 3 mounted with a CPU (central processing unit), a PCMCIA controller 4 (refer to FIG. 2) connected to the CPU and controlling a PCMCIA type card, etc., and an LCD (liquid crystal display) part 2 combined with the main body 3 by a hinge. The main body is provided with an input unit such as a touch pad 7 and a keyboard 9, and a bay 5 in which a wireless LAN card 10 and 20 is inserted. Inside the bay 5 a PCMCIA socket 6 (refer to FIG. 2) electrically connected to the PCMCIA controller 4 is provided.

FIG. 2 is a block diagram showing a PCMCIA wireless LAN card of FIG. 1, which is operable as a memory card. As shown therein, the PCMCIA wireless LAN card comprises a wireless sending/receiving part 20 or 30 sending and receiving a high frequency analog signal by wireless, and a wireless LAN board 10 transmitting data from the main body 3 to the wireless sending/receiving part 20 or 30 after converting data into packet data, and is operable as a memory to store the data. Further, the wireless sending/receiving parts 20 and 30 are different in a specification for a wireless LAN, and each of the wireless sending/receiving parts 20 and 30 is individually connected to the wireless LAN board 10. Hereinbelow, the wireless LAN board 10 will be called a first board and the wireless sending/receiving part 20 or 30 will be called a second board. Further, the wireless sending/receiving part 20 or 30 will be representatively described as the second board.

The first board 10 includes a main body connection part 12 to be connected to the PCMCIA socket 6 of the main body 3, a second board connection part 17 to which the second board 20 or 30 is connected, a memory part 11, a second board sensing part 15 sensing whether or not the second board 20 or 30 is connected, and a controller 13. When the second board 20 or 30 is sensed to be connected to the first board 10, the controller 13 transmits data received through the main body connection part 12 to the second board 20 or 30 through the second board connection part 17 after dividing the data into packet data by buffering the data in the memory part 11. When the second board 20 is sensed to not be connected to the first board 10, the controller 13 controls the memory part 11 to store the data received through the main body 3.

That is, the controller 13 includes a MAC controller 13a converting the data received from the PCMCIA socket 6 into the packet data (i.e., into a unit of data for a network) and controlling access to an external terminal when the second board 20 or 30 is connected to the first board 10, and a memory controller 13b controlling the memory part 11 to store the data received from the main body connection part 12 when the second board 20 or 30 is not connected to the first board 10, according to a sensing signal from the second board sensing part 15.

Thus, the PCMCIA controller 4 of the main body 3 transmits the data to the first board 10, and then the controller 13 converts the data of a bit stream into the data of a packet unit for the network, thereby transmitting the data of the packet unit to the second board 20 or 30.

The second boards 20 and 30 are interchangeable and each is detachably combinable with the first board 10. The second board 20 or 30 detachably combined with the first board 10 includes a respective antenna 25 or 35, a respective baseband processing part 21 or 31 converting a high frequency analog signal directed by the respective antenna 25 or 35 into a low frequency analog signal by filtering an IF (intermediate frequency) signal, a respective A/D converter 22 or 32 converting an analog signal outputted from the respective baseband processing part 21 or 31 into a digital signal and converting a digital signal transmitted from the first board 10 into an analog signal, and a respective RF processing part 23 or 33 converting the signals outputted from the respective A/D converter 22 or 32 into the high frequency analog signal having a specific IF (immediate frequency) and transmitting the analog signal having a specific IF according to the respective second board 20 or 30 through the respective antenna 25 or 35.

Further, the baseband processing parts 21 and 31 use different modulation operations selected according to the respective specifications, 802.11b and 802.11a. That is, a CCK modulation operation is selected for a 802.11b specification, and a OFDM modulation operation is selected for a 802.11a specification.

The RF processing parts 23 and 33 are different according to the respective specifications. That is, a 2.4 GHz RF processing part 23 is used in the 802.11b specification, and a 5 GHz RF processing part 33 is used in the 802.11a specification,

When the first board 10 and second board 20 or 30 are connected to the main body 3, each component thereof is operated as follows. When the first board 10 is connected to the PCMCIA socket 6 of the main body 3, a connection signal is generated and transmitted to the PCMCIA controller 4. Further, the PCMCIA controller 4 initializes a register of the memory part 11 provided in the first board 10. Thereafter, when the second board 20 is connected to the second board connection part 17 of the first board 10, a sensing circuit of the second board sensing part 15 is connected to a preset voltage level (e.g., ground) of the second board 20, so that a signal of a low level is generated and transmitted to the MAC controller 13a of the controller 13 provided in the first board 10. Further, the MAC controller 13a outputs an interrupt signal to the PCMCIA controller 4 through the PCMCIA socket 6. Thus, the PCMCIA controller 4 determines the first board 10 as the wireless LAN card based on the interrupt signal from the MAC controller 13a, and transmits the data (to be wirelessly sent) to the controller 13. The controller 13 divides the data received from the PCMCIA controller 4 into packets, and outputs the data packets to the second board 20 or 30 through the second board connection part 17.

Further, the second board 20 or 30 modulates the data from the controller 13 of the first board 10 and sends the modulated data through the antenna 25 or 35, and demodulates the high frequency analog signal directed by the antenna 25 or 35 and transmits the demodulated analog signal to the controller 13 of the first board 10. Further, the controller 13 of the first board 10 converts the demodulated analog signal into digital data of a bit stream, and transmits the bit stream digital data to the main body 3 through the PCMCIA socket 6.

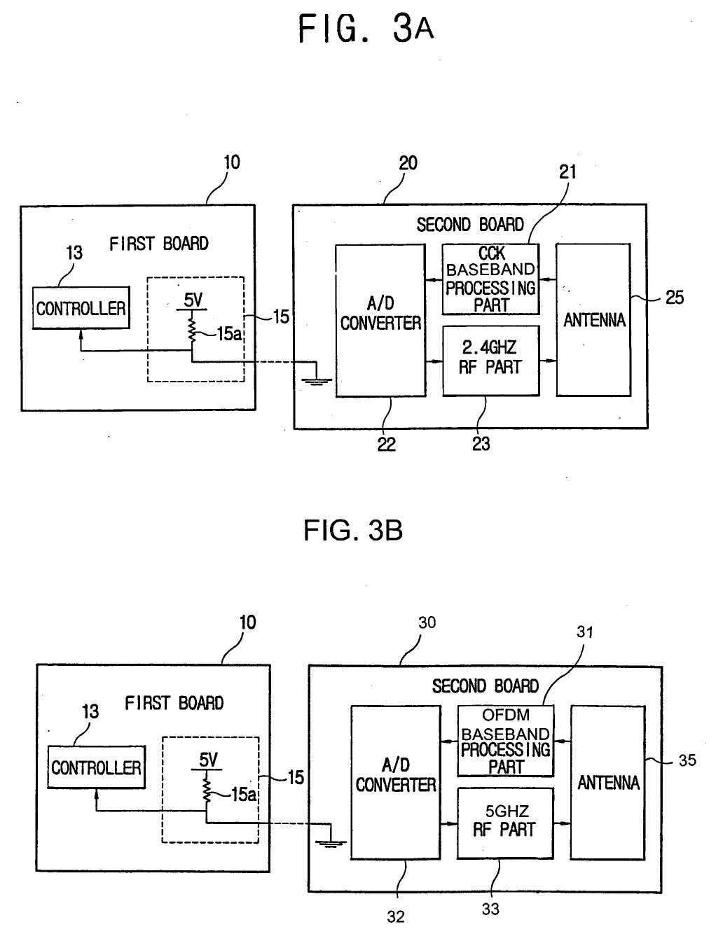

FIGS. 3A and 3B are block diagrams illustrating a circuit diagram of the second board sensing part of FIG. 2. As shown in FIGS. 3A and 3B, the first board 10 includes a resistor 15a, which is connected to an internal power line (not shown) of the first board 10, used as the second board sensing part 15 generating a connection signal when the second board 20 or 30 is connected to the second board connection part 17. The resistor 15a used as the second board sensing part 15 is connected to the preset voltage level (ground) of the second board 20 or 30 when the first board 10 and second board 20 or 30 are connected, and outputs the low level signal. When the first board 10 and second board 20 or 30 are not connected, the second board sensing part 15 outputs a signal of a high level. Thus, the controller 13 determines whether the first board 10 and second board 20 or 30 are connected based on the high level signal or the low level signal.

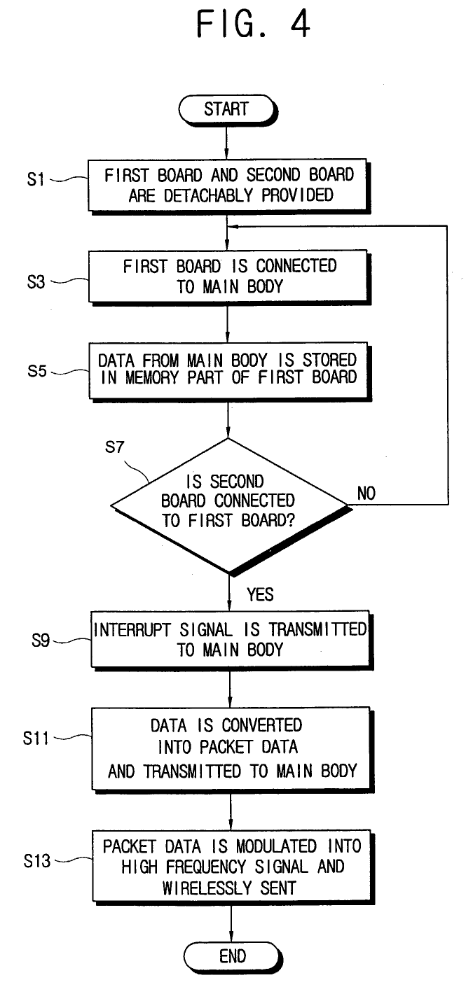

FIG. 4 is a control flowchart of a wireless LAN card which is usable as a memory card according to an embodiment of the present invention. As shown in FIG. 4, operations of the wireless LAN card will be described. At operation S1, there are provided the first board (wireless LAN board) 10 having the memory part 11 and the controller 13, and the second board (wireless transmission board) 20 or 30 modulating and demodulating signals for wireless transmission. At operation S3, the first board 10 is connected to the main body 3, and the CPU of the main body 3 determines the first board 10 as the memory card and outputs data to the first board 10. At operation S5, the first board 10 stores the data from the main body 3 in the memory part 11. Thereafter, at operation S7, the second board sensing part 15 determines whether or not the second board 20 or 30 is connected to the first board 10. When the first board 10 and the second board 20 or 30 are connected, at operation S9, the controller 13 transmits the interrupt signal to the main body 3 so as to change a memory card mode into a wireless LAN card mode. At operation S11, the controller 13 of the first board 10 converts the data from the main body 3 into the packet data, and transmits the packet data to the second board 20 or 30. At operation S13, the second board 20 or 30 modulates the packet data into the high frequency analog signal, and sends the modulated analog signal through the antenna 23 or 33.

With this configuration, there is detachably provided the wireless LAN board and the wireless transmission board which correspond to the MAC controller (MAC layer) and the RF part (physical layer) of the PCMCIA wireless LAN card, respectively. Therefore, a user can interchange the wireless specification of the wireless LAN card between 802.11a and 802.11b by replacing the wireless transmission board (physical layer) of the 802.11a or 802.11b specification with another specification without replacing a whole wireless LAN card. Further, because only the RF part (physical layer) is changed without changing the MAC layer, the costs to change the wireless specification are relatively low to send and receive various IF signals through airwaves. Further, only boards corresponding to the physical layer having the RF processing part and the baseband processing part are manufactured according to frequency regulations of the respective nations separately from the MAC layer, thereby increasing a productive efficiency. Further, the wireless LAN board includes the memory part, so that the wireless LAN board is usable as the memory card.

As described above, a wireless LAN card and an operation of controlling the same is provided, in which the wireless LAN card is usable as a memory card and a wireless sending/receiving part thereof is easily replaceable for one of a desired specification.

Although an embodiment of the present invention has been shown and described, it will be appreciated by those skilled in the art that changes may be made in these embodiments without departing from the principles and spirit of the invention, the scope of which is defined in the appended claims and their equivalents.

What is claimed is:

1. A wireless LAN card connectable to a portable computer having a main body with a PCMCIA socket, comprising:
a wireless transmission board including:
a wireless sending/receiving part to modulate and to demodulate packet data of a frequency modulation range and to send and receive data wirelessly; and
a wireless LAN board including:
a controller to sense whether the wireless transmission board is connected to the wireless LAN board, the wireless LAN board to convert data received through the PCMCIA socket into packet data, and to transmit the packet data to the wireless transmission board.

2. The wireless LAN card according to claim 1, wherein the wireless LAN board comprises:
a main body connection part connectable to the PCMCIA socket;
a connection part to which the wireless transmission board is detachably connected; and
a memory part to store the data received through the main body connection part,
the controller of the wireless LAN board operating in a PCMCIA memory card mode when the wireless transmission board is not connected to the wireless LAN board, and the wireless LAN board storing the data received through the main body connection part in the memory part and reading the data stored in the memory part according to a reading order from the main body so as to transmit the read data to the main body through the PCMCIA socket.

3. The wireless LAN card according to claim 2, wherein the wireless LAN board further comprises:
a connection sensing part to sense whether the wireless transmission board is connected to the wireless LAN board, the controller operating in a wireless LAN card mode when the wireless transmission board is connected to the wireless LAN board, the wireless LAN board outputting an interrupt signal to the main body and transmitting the data from the main body to the wireless transmission board.

4. The wireless LAN card according to claim 3, wherein the wireless sending/receiving part comprises:
an antenna;
an A/D converter converting an analog signal into a digital signal and/or the digital signal into the analog signal;
an RF processing part modulating the packet data received from the controller through the A/D converter into a high frequency analog signal having a specific IF, and sending the high frequency analog signal through the antenna; and
a baseband processing part demodulating a high frequency analog signal directed by the antenna into a low frequency signal by filtering the specific IF, and transmitting the low frequency signal to the controller through the A/D converter.

5. The wireless LAN card according to claim 4, wherein the baseband processing part demodulates the packet data by using one of an OFDM modulation operation and CCK modulation operation.

6. A method of controlling a wireless LAN card connectable to a portable computer having a main body with a PCMCIA socket, comprising:
connecting a wireless LAN board to the PCMCIA socket, the wireless LAN board converting data received though the PCMCIA socket into packet data;
sensing whether a wireless transmission board is connected to the wireless LAN board, the wireless transmission board modulating and demodulating the packet data of a specific frequency modulation range and sending and receiving data wirelessly; and
sending and receiving the packet data wirelessly via the wireless transmission board when the wireless LAN board and the wireless transmission board are connected.

7. The method according to claim 6, wherein the wireless LAN board includes a memory part to store the data received through the PCMCIA socket, the method further comprising:
storing the data in the memory part of the wireless LAN board when the wireless transmission board is not connected to the wireless LAN board;
reading the data stored in the memory part in response to control of the main body; and
transmitting the read data to the main body.

8. The method according to claim 7, further comprising:
transmitting an interrupt signal to the main body through the PCMCIA socket when the wireless transmission board is connected to the wireless LAN board, so that the wireless LAN card operates in a wireless LAN card mode.

9. The method according to claim 8, wherein the wireless transmission board includes an antenna, an RF processing part modulating the packet data of a specific frequency modulation range, and a baseband processing part demodulating a high frequency signal directed by the antenna, the method further comprising:
modulating the packet data transmitted from the wireless LAN board into a high frequency signal having a specific IF; and
sending and receiving the high frequency signal through the antenna.

10. A wireless LAN card connectable to a computing apparatus having a main body with a detachable connection, comprising:
a wireless transmission board detachably connected to a wireless LAN board and comprises:
a wireless sending/receiving part to modulate and to demodulate packet data of a frequency modulation range and to send data to and receive data from the wireless LAN board; and
a wireless LAN board comprising:
a controller to sense whether the wireless transmission board is connected to the wireless LAN board; and
a memory to store the data received from the main body, the wireless transmission board detachably connectable to the wireless LAN board such that when the wireless transmission board is not connected to the wireless LAN board, the memory stores the data received from the main body in the memory and reads the data stored in the memory according to a control by the main body.

11. The wireless LAN card according to claim 10, wherein the detachable connection is a PCMCIA socket.

12. The wireless LAN card according to claim 10, wherein the computing apparatus is a portable apparatus.

13. The wireless LAN card according to claim 10, wherein the computing apparatus is a stationary apparatus.

14. The wireless LAN card according to claim 11, wherein the wireless LAN board comprises:
a main body connection part connectable to the PCMCIA socket; and
a connection part connectable to the wireless transmission board.

15. The wireless LAN card according to claim 14, wherein the controller of the wireless LAN board operates in a PCMCIA memory card mode when the wireless transmission board is not connected to the wireless LAN board, and the wireless LAN board stores the data received through the main body connection part in the memory and reads the data stored in the memory according to a reading order from the main body so as to transmit the read data to the main body through the PCMCIA socket.

16. The wireless LAN card according to claim 10, wherein the controller comprises:
a connection sensing part to sense whether the wireless transmission board is connected to the wireless LAN board, and operates in a wireless LAN card mode when the wireless transmission board is connected to the wireless LAN board, the wireless LAN board outputting an interrupt signal to the main body and providing the data from the main body to the wireless transmission board.

17. The wireless LAN card according to claim 10, wherein the controller comprises:
a connection sensing part to sense whether the wireless transmission board is connected to the wireless LAN board, and operates in a wireless LAN card mode when the wireless transmission board is connected to the wireless LAN board, the wireless LAN board outputting an interrupt signal according to a sensing result of the connection sensing part.

18. The wireless LAN card according to claim 10, wherein the wireless sending/receiving part comprises:
an antenna;
an A/D converter converting an analog signal into a digital signal and/or the digital signal into the analog signal;
an RF processing part modulating the packet data received from the controller through the A/D converter into a high frequency analog signal having a designated IF, and sending the high frequency analog signal through the antenna; and
a baseband processing part demodulating a high frequency analog signal from the antenna into a low frequency signal by filtering the designated IF, and providing the low frequency signal to the controller through the A/D converter.

19. The wireless LAN card according to claim 18, wherein the baseband processing part demodulates the packet data by using one of an OFDM modulation operation and a CCK modulation operation.

20. The wireless LAN card according to claim 10, wherein the frequency modulation range of the wireless LAN card is changeable by a substitution of the detachable wireless transmission board such that either of an OFDM modulation operation and a CCK modulation operation is selectable.

21. A method of controlling a wireless LAN card connectable to a computing apparatus having a main body with a detachable connection, comprising:
connecting a wireless LAN board to the detachable connection, the wireless LAN board converting data received though the detachable connection into packet data;
sensing whether a wireless transmission board is connected to the wireless LAN board, the wireless transmission board modulating and demodulating the packet data of a designated frequency modulation range and sending and receiving data wirelessly; and
sending and receiving the packet data wirelessly via the wireless transmission board when the wireless LAN board and the wireless transmission board are connected.

22. The method according to claim 21, further comprising:
storing the data in a memory of the wireless LAN board when the wireless transmission board is not connected to the wireless LAN board;
reading the data stored in the memory in response to a control of the main body; and
providing the read data to the main body.

23. The method according to claim 22, further comprising:
providing an interrupt signal to the main body when the wireless transmission board is connected to the wireless LAN board, so that the wireless LAN card operates in a wireless LAN card mode.

24. The method according to claim 21, further comprising:
modulating the packet data transmitted from the wireless LAN board into a high frequency signal having a preset IF; and
sending and receiving the high frequency signal wirelessly.

25. The method according to claim 21, wherein the detachable connection is a PCMCIA socket.

26. The method according to claim 21, wherein the computing apparatus is a portable apparatus.

27. The method according to claim 21, wherein the computing apparatus is a stationary apparatus.

28. The method according to claim 21, wherein the frequency modulation range of the wireless LAN card is changeable by a substitution of the detachable wireless transmission board such that either of an OFDM modulation operation and a CCK modulation operation is selectable.

29. A method of controlling a wireless LAN card having a wireless transmission board and a wireless LAN board, the wireless LAN board connectable to a computing apparatus having a main body by a detachable connection, comprising:
connecting the wireless LAN board to the main body;
sending and receiving data from the main body to the wireless LAN board;
sensing whether the wireless transmission board is connected to the wireless LAN board;
storing the data received from the main body, when the wireless transmission board is not connected to the wireless LAN board; and
converting data into packet data for a wireless transmission, when the wireless transmission board is connected to the wireless LAN board.

30. The method according to claim 29, further comprising:
modulating and demodulating the packet data of a frequency modulation range; and
sending and receiving wirelessly the modulated packet data.

31. A wireless LAN card connectable to a computing apparatus having a main body with a detachable connection, comprising:
a wireless LAN board, when connected to the main body sends and receives data to the main body of the computing apparatus; and
two wireless transmission boards detachably interchangeable, one of which is connected to the wireless LAN board, the one wireless transmission board connected to the wireless LAN board modulates and demodulates packet data of a frequency modulation range and sends data to and receives data from the wireless LAN board, the frequency modulation range of the wireless LAN card is changeable by a substitution of the other detachably interchangeable wireless transmission board such that either of a first modulation range or a second modulation range is selectable.

32. The wireless LAN card according to claim 10, wherein the first and second modulation ranges are selectable corresponding to an OFDM modulation operation and a CCK modulation operation, respectively.

33. A method of controlling a wireless LAN card having two detachably interchangeable wireless transmission boards and a wireless LAN board, the wireless LAN board connectable to a computing apparatus having a main body with a detachable connection, comprising:
connecting the wireless LAN board to the main body; and
interchanging one of the wireless transmission boards by detaching one of the two wireless transmission boards and attaching the other one of the two wireless transmission boards.

34. The method according to claim 33, further comprising:
selecting a modulation operation according to a respective wireless transmission board attached to the wireless LAN card.

35. The method according to claim 33, further comprising:
performing an OFDM modulation operation or a CCK modulation operation according to a respective wireless transmission board attached to the wireless LAN card.
